(19) United States
(12) Patent Application Publication
(10) Pub. No.: US 2025/0122726 A1
(43) Pub. Date: Apr. 17, 2025

(54) Type of waterproofing membrane connection technology, waterproofing membrane and prefabricated parts

(71) Applicant: Cowinter (Suzhou) Technology Limited, Suzhou City Jiangsu Province (CN)

(72) Inventor: Zhiqiang Zou, Suzhou City (CN)

(73) Assignee: Cowinter (Suzhou) Technology Limited, Suzhou City Jiangsu Province, OT (CN)

(21) Appl. No.: 18/543,370

(22) Filed: Dec. 18, 2023

(30) Foreign Application Priority Data
Oct. 17, 2023 (CN) 202311341887.6

(51) Int. Cl. E04D 5/14; E04D 13/14

(52) U.S. Cl. CPC E04D 5/149; E04D 5/142; E04D 13/1407

(57) ABSTRACT

The invention provides a detailing process with waterproofing membrane parts and prefabricated accessories which includes below steps: place the first layer membrane on the base template while the edge of the first layer membrane beveled; place the edge of the second layer membrane partially overlapped with the edge of the first layer membrane and then fix the position, and place the membrane edge with bevel to the surface of the second layer membrane fittingly; the edge of the second layer is beveled; and the second bevel is directed towards the direction of the first layer membrane. Press together and make the second chamfered surface fixedly connected to the surface of the first layer. The waterproofing parts connection based on this process has high structural strength, a more complete and unified appearance, improves the waterproofing performance of the parts and accessories, and significantly enhances the service life of the membrane.

### REFERENCE TO PRIOR APPLICATION

This application claims priority to Chinese Patent Application 202311341887.6, filed on Oct. 17, 2023, which is incorporated herein by reference.

### TECHNICAL FIELD

The invention belongs to the technical field of preparing building insulation and protective components, and in particular relates to a waterproofing membrane connection process, waterproofing membrane parts and prefabricated parts.

### BACKGROUND TECHNIQUE

Polymer reinforced waterproofing membrane is a green, environmentally friendly and energy-saving material commonly used for roofing of large industrial and commercial factories, data centers and other domestic and foreign buildings. Because the polymer material has strong ductility and aging resistance, puncture resistance and tear resistance, it is excellent the hot air weldable performance that makes it an ideal waterproof layer for the exposed roof surface. The waterproofing membrane is made of anti-UV, anti-aging and other materials. Through the lamination process, it has achieved strong resistance to external force deformation and long-term ultraviolet and heat resistance, radiation, waterproof and thermal insulation and other performance requirements enable the service life of the overall material to reach more than 25 years.

When the above-mentioned waterproofing membranes are used, they are usually laid in a complete roll, and mechanically fixed with screws through the insulation layer with membranes, and hot air welding is used to achieve a hot-melt sealing overlap between the membranes. Prefabricated waterproofing accessories in factory with the same waterproofing membranes are used to detail flashing the overlapping joints of the roof penetrations such as pipes, roof drainage, inside or outside corners and membrane joints.

In the current field of waterproofing membrane manufacturing technology domestically and internationally, although the existing membrane manufacturing technology can make the membrane itself have good water resistance, the waterproofness of the connections between different flashing joints is often poor. The existing mainstream method to improve the waterproofness of membrane joints is the sealant sealing method, which uses sealing agents to seal the edges of the membranes. However, this method often requires manual operation which has low production efficiency and the consistent quality is hard to guarantee. Other ways to improve waterproofing based on sealing strips, welding, etc. will significantly increase the overall production and add costs of the product.

Therefore, it is necessary to improve the connection process between existing waterproofing membranes.

### Contents of the Invention

The purpose of the embodiments of the present application is to provide a waterproofing membrane connection process, aiming to solve the problem that the waterproofness of the connections between different existing waterproofing membrane structures is often poor, shortening the service life of the waterproofing membrane.

The embodiment of the present application is implemented by providing a waterproofing membrane connection process. The waterproofing membrane preparation process includes the following steps:
The first layer of waterproofing membrane is placed on the base, and the edge of the first layer of waterproofing membrane is beveled to form a first bevel;
The edge of the second layer of waterproofing membrane overlaps the edge of the first layer of waterproofing membrane and is fixedly connected, and the first beveled surface is attached to the surface of the second layer of waterproofing membrane, so that the first layer of waterproofing membrane The reinforcement layer inside the membrane is not in contact with the air, and the reinforcement layer provided inside the first layer of waterproofing membrane is used to improve the structural strength of the first layer of waterproofing membrane;
The edge of the second layer of waterproofing membrane is beveled to form a second bevel; the second bevel is pressed in the direction of the first layer of waterproofing membrane, and the second bevel is fixedly connected on the surface of the first layer of waterproofing membrane, the reinforcement layer inside the second layer of waterproofing membrane is not in contact with the air. The reinforcement layer inside the second layer of waterproofing membrane is used to improve the strength of the second layer of waterproofing membrane structural strength.

Another object of the embodiments of the present application is to provide a waterproofing membrane. The waterproofing membrane is formed by joining together several waterproofing membranes, and the gap between each two adjacent waterproofing membranes is based on the waterproofing membrane as described above. Material connection process is used to connect.

Another object of the embodiments of the present application is to provide a prefabricated part, which is composed of several waterproofing membrane materials. The prefabricated part is composed of an annular bottom membrane and a cylindrical cylinder connected to each other. The inner ring diameter of the annular bottom membrane is the same as the diameter of the cylindrical cylinder;

One end of the cylindrical cylinder is connected to the inner ring of the annular bottom membrane based on the above-mentioned connection process of waterproofing membrane.

The waterproofing membrane connection process provided by the embodiment of the present application can enhance the structural strength of the waterproofing membrane, make its appearance more complete and unified, improve the waterproof sealing of the waterproof membrane, and significantly enhance the service life of the membrane.

### DESCRIPTION OF THE DRAWINGS

FIG. 1 is a schematic diagram of the connection process of a waterproofing membrane provided by an embodiment of the present application;

FIG. 2 is a schematic diagram of the connection process of another waterproofing membrane provided by the embodiment of the present application;

FIG. 3 is a schematic diagram of a bevel angle;

FIG. 4 is a schematic diagram of three types of waterproofing membranes after bevel cutting;

FIG. 5 is a schematic diagram of a prefabricated part;

FIG. 6 is a cross-sectional schematic diagram of a waterproofing membrane;

FIG. 7 is a schematic cross-sectional view of A in FIG. 5;

FIG. 8 is a step diagram of a waterproofing membrane connection process provided by an embodiment of the present application.

Among them, 10, the first waterproof membrane; 11, the first bevel; 20, the second waterproof membrane; 22, the second bevel; 30, the reinforcement layer.

### DETAILED WAYS

In order to make the purpose, technical solutions and advantages of the present invention clearer, the present invention will be further described in detail below with reference to the accompanying drawings and embodiments. It should be understood that the specific embodiments described here are only used to explain the present invention and are not intended to limit the present invention.

It will be understood that the terms “first”, “second”, etc. used in this application may be used to describe various elements herein, but these elements are not limited by these terms unless otherwise specified. These terms are only used to distinguish one element from another element. For example, without departing from the scope of the present application, the first layer of waterproofing membrane may be referred to as a second layer of waterproofing membrane, and similarly, the second beveled surface may be referred to as a first beveled surface.

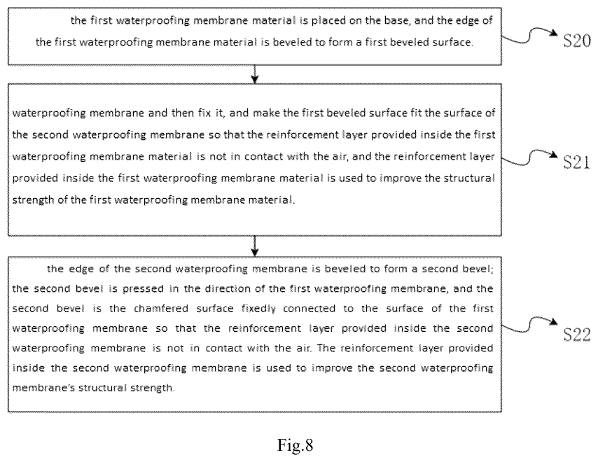

FIG. 8, in one embodiment, a connection process of waterproofing membrane is proposed. The waterproofing membrane preparation process may specifically include the following steps:

In step S20, the first layer of waterproofing membrane material is placed on the base, and the edge of the first layer of waterproofing membrane material is beveled to form a first beveled surface.

Step S21, overlap the edge of the second layer of waterproofing membrane with the edge of the first layer of waterproofing membrane and then fix it, and make the first beveled surface fit the surface of the second layer of waterproofing membrane so that the reinforcement layer provided inside the first layer of waterproofing membrane material is not in contact with the air, and the reinforcement layer provided inside the first layer of waterproofing membrane material is used to improve the structural strength of the first layer of waterproofing membrane material.

Step S22, the edge of the second layer of waterproofing membrane is beveled to form a second bevel; the second bevel is pressed in the direction of the first layer of waterproofing membrane, and the second bevel is the chamfered surface fixedly connected to the surface of the first layer of waterproofing membrane so that the reinforcement layer provided inside the second layer of waterproofing membrane is not in contact with the air. The reinforcement layer provided inside the second layer of waterproofing membrane is used to improve the second layer of waterproofing membrane's structural strength.

Those skilled in the waterproofing and roofing field know that polymer reinforced waterproofing membranes are green, environmentally friendly and energy-saving materials commonly used for roofs of large industrial and commercial plants, data centers, etc. domestically and internationally. Because polymer materials have strong ductility and aging resistance, they are also puncture-resistant and peel-off properties and excellent hot-air weldability make it an ideal waterproofing layer for exposed roof surfaces, with a service life of up to decades.

Currently, there is a prominent problem in the waterproofing membrane prefabricated parts on the domestic and foreign markets. That is, in order to enhance the structural strength of the waterproofing membrane, it is often necessary to use internal reinforcement made of polymers. Therefore, it needs to be pointed out that this application is based on the study of a large number of cases of waterproofing failure membranes and found that false welding and missing welding breakpoints at the reinforcement are key factors that lead to loopholes in the overall waterproofing of the membrane. Furthermore, when weak welds and breakpoints occur, when the pores of the reinforcing material in the waterproofing membrane are close to vacuum, the water end and water molecules will form vacuum pores. The atmospheric pressure will exceed the vacuum pressure inside the reinforcing ribs, and water will enter the fabric. pores, thereby causing the reinforcement structure to be damaged. After absorbing water for a long time, the waterproofing of the membrane will fail. The existing mainstream sealing or connection process between waterproofing membranes uses sealing plasters formed by various preparations. However, such materials are also difficult to avoid the above problems, and the sealing paste sealing often requires manual filling, and the cost of sealant material is high, and labor costs, time costs, and whether the durability of the sealant and the roll material have the same lifespan will all bring obvious problems to the use of this type of process. Waterproof panels made based on the injection molding process require different molds in different usage scenarios, which significantly increases the production and procurement costs of the product. Therefore, it can be seen that the existing processes have high limitations, and it is difficult to find a balance between improving the waterproofness of the product, production cost, manufacturing efficiency and other factors.

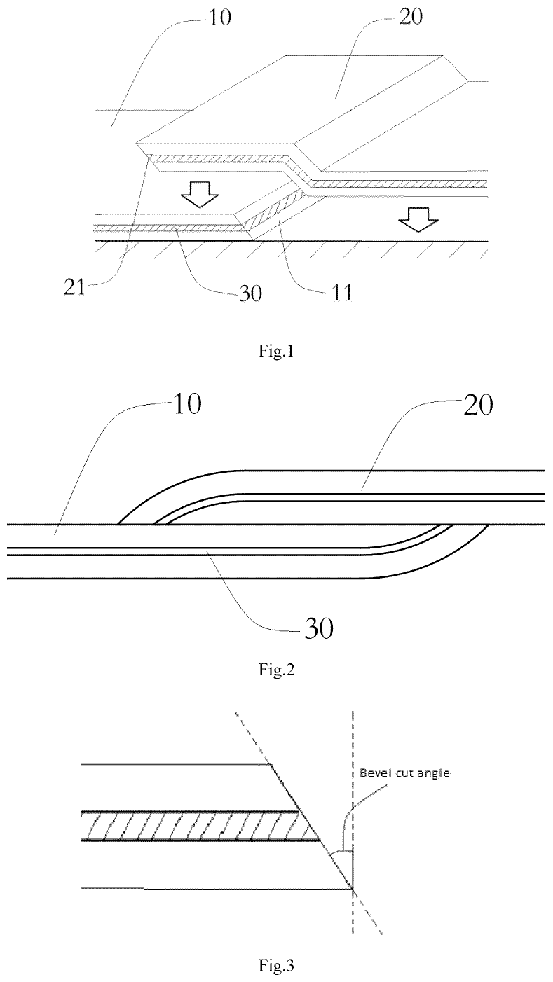

Based on the above problems, this process is proposed. In the embodiment of the present application, the beveled edge-pressing heat welding technology is used to join the waterproof membranes, thereby improving the sealing and waterproof properties of the waterproof membranes. As shown in FIG. 1, the first layer of waterproofing membrane can be placed on the base first, and can be fixed by vacuum adsorption. The edge of the first layer of waterproofing membrane is beveled to form a first bevel. The angle of the bevel is as follows as shown in the figure, at this time, after partially overlapping the edge of the second layer of waterproofing membrane with the edge of the first layer of waterproofing membrane, they are fixedly connected through heat welding, and the first beveled surface is made to fit through pressure heat welding. on the surface of the second layer of waterproofing membrane. The first beveled surface can be pressurized, as shown in FIG. 2, so that it actively fits the surface of the second layer of waterproofing membrane; the surface of the second layer of waterproofing membrane can also be pressurized, so that it actively fits the surface of the first layer of waterproofing membrane bevel cut. After diagonal cutting, it is then thermally welded and pressed together, so that the reinforcement layer inside the first layer of waterproofing membrane is completely isolated from the air. Similarly, the method of bonding the second chamfered surface to the first layer of waterproofing membrane can be as described above. The laminating operations of the above three mutually contacting planes can be performed simultaneously or in steps. The bonding method can be physical or chemical bonding, welding, etc., and is not limited here.

Through the above method, the structural strength of the waterproofing membrane can be enhanced, and the appearance of the waterproofing membrane can be made more completed and unified, the waterproof sealing performance of the waterproof sheet material can be improved, and the service life of the waterproofing membrane can be significantly enhanced. It can be understood that the first layer of waterproofing membrane and the second layer of waterproofing membrane can also be two different sides of the same membrane. The two sides can be bonded to each other to form a component. For the convenience of description, they will be They are called the first layer of waterproofing membrane and the second layer of waterproofing membrane.

In one embodiment, the first layer of waterproofing membrane and the second layer of waterproofing membrane are both made of three layers of materials. The middle layer of the three layers of materials is a reinforcement layer with a grid structure for reinforcing the waterproofing membrane. The structural strength of the material;

The two sides of the grid structure reinforcement layer are respectively a structural surface layer and a structural bottom layer. The structural surface layer is used for waterproofing and UV resistance, and the structural bottom layer is used to provide structural support.

In the embodiment of this application, the structural surface can be made of waterproof and UV-resistant materials, such as a light-colored UV (ultraviolet)-resistant surface, and the structural bottom layer can be made of dark color and has a certain structural strength, which can be easily bonded or welded. After welding based on the method in this embodiment, as shown in FIG. 2, the structural surface of the first layer of waterproofing membrane and the structural surface of the second layer of waterproofing membrane are connected to each other, and there are no seams or breakpoints in the connection, so the overall aesthetics Significant improvement, while avoiding the middle reinforcement layer from contact with the air.

In one embodiment, the angle between the bevel plane formed after the first layer of waterproofing membrane is bevel-cut and the plane of the membrane surface is not less than 40°.

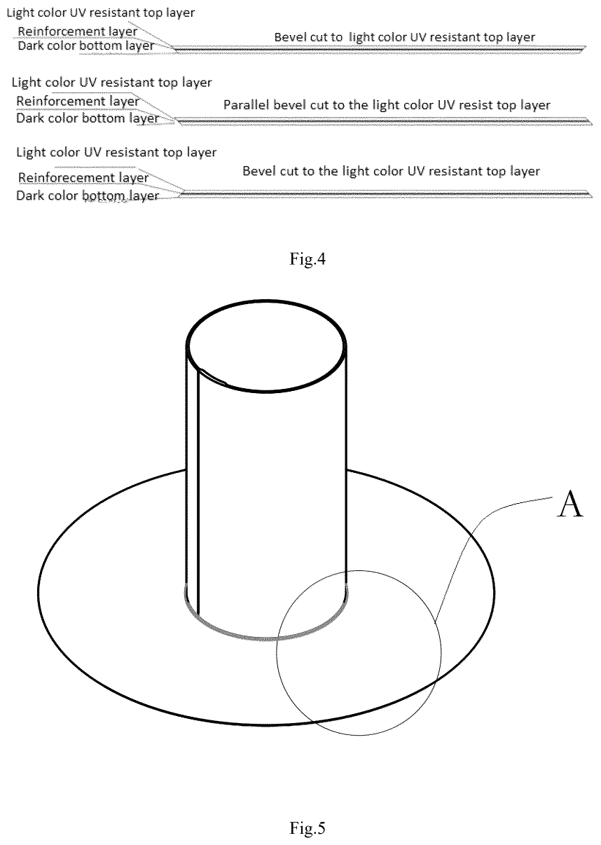

As shown in FIG. 3, a schematic diagram of a bevel angle is provided. The angle should not be too small. Since the membrane has a certain hardness, when the angle is too small, it will be difficult for the bevel surface to fit perfectly with the structural surface or the bottom surface of the structure, making it difficult to be firm. Fitting will bring hidden dangers to sealing. Preferably, the included angle is 45 degree.

In one embodiment, the connection method in which the edge of the second layer of waterproofing membrane partially overlaps the edge of the first layer of waterproofing membrane is thermal welding;

The connection method between the first beveled surface and the surface of the second waterproof membrane, and the connection method between the second beveled surface and the surface of the first waterproof membrane are both thermal welding.

The use of pressure heat welding is beneficial to reducing costs and enables the above three surface connections to be performed simultaneously.

In one embodiment, the first layer of waterproofing membrane is beveled so that the area of its structural surface is smaller than the area of its structural bottom layer, and the second layer of waterproofing membrane is beveled so that the area of its structural surface is larger than its structural surface. The area of the ground floor,

The first bevel is connected to the structural bottom layer of the second waterproof membrane, and the second bevel is connected to the structural surface of the first waterproof membrane.

In the embodiment of this application, as shown in FIG. 4, three styles of waterproofing membrane are provided to meet different actual usage scenarios. The above three types of membranes can be connected using the method provided in the embodiment of the present application to prevent the reinforcing layer from being exposed to the air and improve the waterproof effect.

In one embodiment, the reinforcement layer may be formed from an inner reinforced polyester fiber mesh structure or other structures with structural reinforcement.

In one embodiment, a waterproofing membrane is provided. The waterproofing membrane is formed by joining together several waterproofing membranes, and the connection process between each two adjacent waterproofing membranes is based on the above-mentioned waterproofing membrane. Make a connection.

In the embodiment of the present application, the description of the connection process of the waterproofing membrane can be found above and will not be described again here. The waterproofing membrane connection process provided by the embodiment of the present application can enhance the structural strength of the waterproofing membrane, make its appearance more complete and unified, improve the waterproof sealing of the waterproof membrane, and significantly enhance the service life of the membrane.

In one embodiment, a prefabricated part is provided. The prefabricated part is composed of several waterproofing membranes. The prefabricated part is composed of an annular base membrane and a cylindrical cylinder connected to each other. The annular bottom membrane is connected to each other. The diameter of the inner ring of the base membrane is the same as the diameter of the cylindrical cylinder;
is connected to the inner ring of the annular bottom membrane based on the connection process of the waterproofing membrane described in any one of claims 1-6.

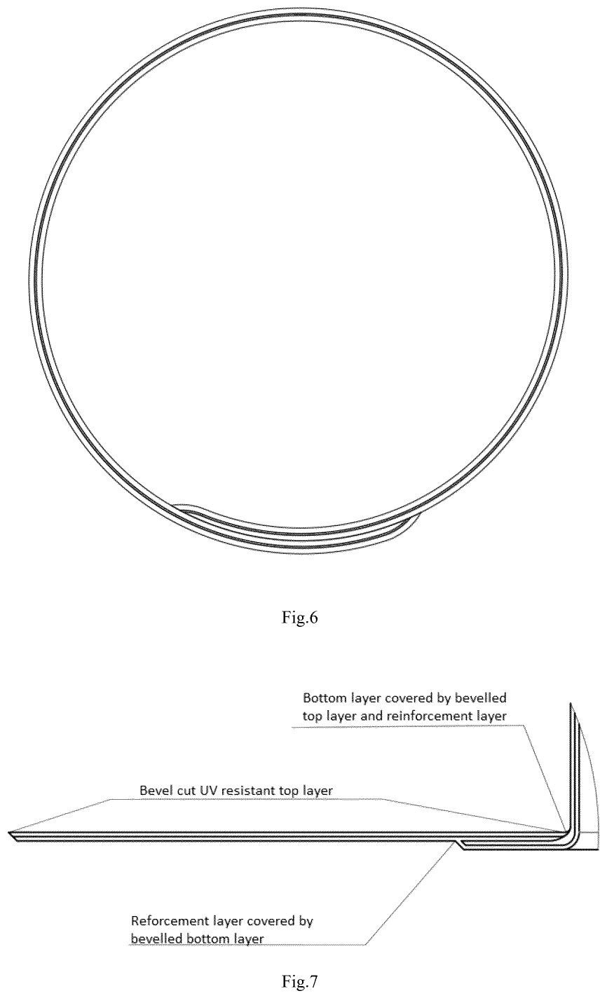

In the embodiment of the present application, as shown in FIG. 5, it is a prefabricated part. The cross section of the cylindrical cylinder in the prefabricated part can be as shown in FIG. 6. In FIG. 6, the distance between the two sides of the waterproofing membrane is the connection method can be based on the connection process of the waterproofing membrane mentioned above. The connection method between the cylindrical shape and the bottom ring can be shown in FIG. 7. The connection method between the ring and the cylinder can be based on the connection process of waterproofing membrane as mentioned above.

In the embodiment of the present application, the description of the connection process of the waterproofing membrane can be found above and will not be described again here. The waterproofing membrane connection process provided by the embodiment of the present application can enhance the structural strength of the waterproofing membrane, make its appearance more completed and unified, improve the waterproof sealing of the waterproof membrane, and significantly enhance the service life of the membrane. It can be understood that the cylinder and ring structures given in the embodiments of the present application are examples, and they can also be conical, flat, etc., and are not limited here.

It should be understood that although various steps in the flowcharts of various embodiments of the present application are shown in sequence as indicated by arrows, these steps are not necessarily executed in the order indicated by arrows. Unless explicitly stated in this article, there is no strict order restriction on the execution of these steps, and these steps can be executed in other orders. Moreover, at least some of the steps in each embodiment may include multiple sub-steps or multiple stages. These sub-steps or stages are not necessarily executed at the same time, but may be executed at different times. The order of execution is not necessarily sequential, but may be performed in turn or alternately with other steps or sub-steps of other steps or at least part of the stages.

The technical features of the above-described embodiments can be combined in any way. To simplify the description, not all possible combinations of the technical features in the above-described embodiments are described. However, as long as there is no contradiction in the combination of these technical features, all should be considered to be within the scope of this manual.

The above-described embodiments only express several implementation modes of the present application, and their descriptions are relatively specific and detailed, but should not be construed as limiting the patent scope of the present application. It should be noted that, for those of ordinary skill in the art, several modifications and improvements can be made without departing from the concept of the present application, and these all fall within the protection scope of the present application. Therefore, the protection scope of this patent application should be determined by the appended claims.

What is claimed is:

1. A waterproofing membrane connection process, characterized in that the waterproofing membrane preparation process includes the following steps:
the first layer of waterproofing membrane is placed on the base, and the edge of the first layer of waterproofing membrane is beveled to form a first bevel;
the edge of the second layer of waterproofing membrane overlaps the edge of the first layer of waterproofing membrane and is fixedly connected, and the first beveled surface is attached to the surface of the second layer of waterproofing membrane, so that the reinforcement layer of the first layer of waterproofing membrane is not in contact with the air, and the reinforcement layer provided inside the first layer of waterproofing membrane is used to improve the structural strength of the first layer of waterproofing membrane;
the edge of the second layer of waterproofing membrane is beveled to form a second bevel; the second bevel is pressed in the direction of the first layer of waterproofing membrane, and the second bevel is fixedly connected on the surface of the first layer of waterproofing membrane, the reinforcement layer provided inside the second layer of waterproofing membrane is not in contact with the air, the reinforcement layer provided inside the second layer of waterproofing membrane is used to improve the strength of the second layer of waterproofing membrane.

2. A waterproofing membrane connection process according to claim 1, characterized in that the first layer of waterproofing membrane and the second layer of waterproofing membrane are made of three layers of materials, and the middle of the three layers of materials is the layer of a reinforcement layer with a grid structure, used to enhance the structural strength of the waterproofing membrane;
the two sides of the grid structure reinforcement layer are respectively a structural surface layer and a structural bottom layer, the structural surface layer is used for waterproofing and UV resistance, and the structural bottom layer is used to provide structural support.

3. The connection process of waterproofing membrane according to claim 1, characterized in that the angle between the bevel plane formed after the first layer of waterproofing membrane is beveled and the plane where the surface of the membrane is located no less than 40 degree.

4. The connection process of waterproofing membrane according to claim 1, characterized in that the connection method in which the edge of the second layer of waterproofing membrane partially overlaps the edge of the first layer of waterproofing membrane is welded together by thermal welding;
the connection method between the first beveled surface and the surface of the second waterproof membrane, and the connection method between the second beveled surface and the surface of the first waterproof membrane are both thermal welding.

5. The connection process of waterproofing membrane according to claim 2, characterized in that after the first layer of waterproofing membrane is beveled, the area of its structural surface is smaller than the area of its structural bottom layer, after the second layer of waterproofing membrane is beveled, the area of the surface layer of the structure is larger than the area of the bottom layer of the structure;
the first bevel is connected to the structural bottom layer of the second waterproof membrane, and the second bevel is connected to the structural surface of the first waterproof membrane.

6. The connection process of waterproofing membrane according to claim 1, characterized in that the reinforcement layer is formed of an inner reinforced polyester fiber mesh structure.

7. A waterproofing membrane, characterized in that the waterproofing membrane is formed by joining together several waterproofing membranes, and the distance between each two adjacent waterproofing membranes is based on claim 1, connect the waterproofing membranes using the above-mentioned connection process.

8. A prefabricated part, characterized in that the prefabricated part is composed of a plurality of waterproofing membrane materials, and the prefabricated part is composed of an annular bottom membrane and a cylindrical cylinder connected to each other, and the annular bottom membrane is the diameter of the inner ring is the same as the diameter of the cylindrical cylinder; is connected to the inner ring of the annular bottom membrane based on the connection process of the waterproofing membrane described in claim 1.

9. A prefabricated part based on claim 8, characterized in that the cylinder is formed by connecting opposite sides of a rectangular waterproofing membrane and bending it in an annular shape, and a set of mutually connected opposite sides.
